(19) United States
(12) Patent Application Publication
(10) Pub. No.: US 2015/0284260 A1
(43) Pub. Date: Oct. 8, 2015

(54) COUNTERTOP FLUID DISPENSER

(71) Applicant: KX Technologies LLC, West Haven, CT (US)

(72) Inventors: Stephen P. Huda, Shelton, CT (US); Amos Toh, Loyang (SG); Ooi Sheau Feng, (SG); Hoon Wee Toon, (SG); John Brunt, Trumbull, CT (US)

(21) Appl. No.: 14/476,787

(22) Filed: Sep. 4, 2014

Related U.S. Application Data
(63) Continuation-in-part of application No. 29/498,111, filed on Jul. 31, 2014, now Pat. No. D733482.
Application No. 29/498,111 is a continuation-in-part of application No. 29/486,906, filed on Apr. 3, 2014, now Pat. No. D734085.

(51) Int. Cl. C02F 1/00; B01D 27/10; B01D 27/14

(52) U.S. Cl. CPC C02F 1/003; B01D 27/146; B01D 27/108; C02F 1/008; C02F 2307/04; C02F 2103/04

(57) ABSTRACT

A countertop water dispenser having a three tiered reservoir system for filtering water and providing immediate dispensing via a spigot, and simultaneously filling a removable pitcher for transporting filtered water to another location. Water flow in the three tiered reservoir system may be controlled by flow valves that float with rising water to stop water flow when a maximum fill level is reached in a reservoir. A flow valve is provided in the middle reservoir as well as the lower reservoir to control the amount of filtered water in each reservoir. An air vent is provided on a filter housing, the air vent venting to a heightened arcuate rib on the countertop dispenser cover. The removable pitcher is mated to the lower reservoir via a pitcher filling mechanism that includes respective plunger or pin valves to allow water to flow into the pitcher when the lower reservoir is filled with water above or equal to the height of the pitcher filling mechanism.

### BACKGROUND OF THE INVENTION

1. Field of the Invention

The present invention generally relates to the dispensing of filtered fluid, such as water, within enclosed spaces. More specifically, the invention relates to a three-tiered reservoir, filtered water dispenser suitable for use on a kitchen countertop, which provides for ambient, filtered water. Additionally, the present invention relates to an accessible, portable water dispenser of filtered water, such as a pitcher, attachable to the countertop dispensing unit.

2. Description of Related Art

It has become increasingly popular due to health fears concerning piped in municipal water supply to acquire other forms of water filtration at the point-of-use for use in the home. In the home, there has been an increased demand for bottled water from a known source. The water has been typically sold as spring, mountain purified, or distilled water. While the demand for bottled water has increased in the home, it has not replaced the convenience of tap water available from the municipal supplier, and bottled water has proven more costly. Consequently, prior art designs for countertop dispensers have become available in the marketplace in an attempt to meet the demand for convenient point-of-use water filtration.

Most countertop dispensers are gravity-fed pitcher designs. Typically, they consist of a two-stage reservoir system with unfiltered water traversing from a first (top) reservoir through a filter media to a second (lower) dispensing reservoir. These are generally simple designs that do not include flow control or shut-off mechanisms between reservoirs, and thus do not attempt to provide a more efficient filtering scheme, or maximize the amount of water being filtered at any one time. Additionally, the pitcher designs of the prior art do not provide any versatility for the user to use the countertop filtration device as a water feed station with immediate dispensing capabilities, while simultaneously providing portability for use away from the countertop.

### SUMMARY OF THE INVENTION

Bearing in mind the problems and deficiencies of the prior art, it is therefore an object of the present invention to provide a countertop fluid dispenser that provides filtration and convenient dispensing capabilities.

It is another object of the present invention to provide a countertop water dispenser that utilizes a three-tiered reservoir system to facilitate different dispensing modes while minimizing the amount of residual or stagnant water remaining therein.

A further object of the invention is to provide a countertop water dispenser with a removably attachable pitcher for remote transport of filtered water, where the countertop water dispenser provides an automatic fill for the pitcher when the pitcher is attached to the countertop dispenser station.

The above and other objects, which will be apparent to those skilled in the art, are achieved in the present invention which is directed to a fluid dispenser comprising: a removable cover having a first aperture for fluid ingress; a first reservoir for receiving ingress fluid, the first reservoir having a bottom surface with a second aperture therethrough; a filter assembly located within the first reservoir and forming a fluid-tight seal with the second aperture within the first reservoir bottom surface; a second reservoir having a bottom surface with a third aperture therethrough, the second reservoir located adjacent the first reservoir, and in fluid communication with the first reservoir, such the second reservoir receives filtered fluid from the filter assembly; and a third reservoir located adjacent the second reservoir, the third reservoir in fluid communication with the second reservoir, such that the third reservoir receives filtered fluid from the second reservoir, and provides at least one dispenser for fluid egress.

The fluid dispenser may include a pre-filter slideably attachable to the first aperture of the removable cover.

In at least one embodiment, the fluid dispenser comprises a first flow valve located within the second reservoir, the first flow valve having a bottom surface forming a recess for entrapping air when the second reservoir fills with fluid, and a first seal aligned with the second aperture such that when the second reservoir reaches a maximum fill level, the first flow valve rises with a pre-determined buoyancy force, such that the first seal of the first flow valve stops fluid flow from the first reservoir to the second reservoir.

The fluid dispenser may also include a second flow valve located within the third reservoir, the second flow valve having a bottom surface forming a recess for entrapping air when the third reservoir fills with fluid, and a second seal aligned with the third aperture such that when the third reservoir reaches a maximum fill level, the second flow valve rises with a pre-determined buoyancy force, such that the second seal of the second flow valve stops fluid flow from the second reservoir to the third reservoir.

The pre-determined buoyance force of the first flow valve is calculated for a cylindrical recess of the first flow valve from the expression:

$$\{ {π ( \frac{{D}_{o}}{2} )}^{2} - {π ( \frac{{D}_{i}}{2} )}^{2} \} ⋆ h ⋆ {δ}_{ω} > Wp$$

where, Dₒ is the inside diameter of the outer sidewall that forms the outer wall of the first flow valve recess; Dᵢ is outside diameter of inner sidewall that forms the inner wall of the first flow valve recess; h is the height of the recess; δ_{ω} is density of the fluid; and Wₚ is the weight of the first flow valve.

The pre-determined buoyance force of the second flow valve is calculated for a cylindrical recess of the second flow valve from the expression:

$$\{ {π ( \frac{{D}_{o}}{2} )}^{2} - {π ( \frac{{D}_{i}}{2} )}^{2} \} ⋆ h ⋆ {δ}_{ω} > Wp$$

where, Dₒ is the inside diameter of the outer sidewall that forms the outer wall of the second flow valve recess; Dᵢ is outside diameter of inner sidewall that forms the inner wall of the second flow valve recess; h is the height of the recess; δ_{ω} is density of the fluid; and Wₚ is the weight of the second flow valve.

The pre-filter may comprise a cylindrical housing having a top circumferential lip and the first aperture in the removable cover includes a shelf structure for supporting the pre-filter cylindrical housing circumferential lip.

The pre-filter may also include a pre-filter filter media designed as a first stage filtration component for sediment, comprising a cloth, mesh, fabric, paper, or any combination thereof, which may be treated for microbiological contaminants.

The filter assembly may include: a filter assembly filter media having a top cover and a bottom cover, the top cover including a post for air egress, the bottom cover including a post for fluid egress; and a filter housing including a filter housing top and filter housing sidewalls encompassing the filter assembly filter media, the filter housing having apertures for fluid ingress.

The filter housing top is configured to include an elongated vent or tube in communication with the top cover post of the filter assembly filter media, the vent or tube having a top portion extending above the filter housing top above a maximum fill line of the first reservoir to release air and prevent fluid ingress.

The removable cover includes at least one heightened arcuate ridge to receive and allow air egress from the vent or tube top portion.

The fluid dispenser may also include a pitcher removably attachable to, and in fluid communication with, the third reservoir, or a spigot in fluid communication with the third reservoir, or both.

In a second aspect, the present invention is directed to a fluid dispenser comprising: a removable top cover having a first aperture for fluid ingress; a pre-filter supported by the removable cover; a first reservoir for receiving ingress fluid, the first reservoir having a bottom surface with a second aperture therethrough, the first reservoir bottom surface contoured to receive a filter assembly, the second aperture formed within the contoured surface; the filter assembly located within the first reservoir and forming a fluid-tight seal with the second aperture, the filter assembly including: a filter assembly filter media having a top cover and a bottom cover, the top cover including a post for air egress, the bottom cover including a post for fluid egress; and a filter housing including a filter housing top and filter housing sidewalls encompassing the filter assembly filter media, the filter housing having apertures for fluid ingress; a second reservoir having a bottom surface with a third aperture therethrough, the second reservoir located adjacent the first reservoir, and in fluid communication with the first reservoir, such the second reservoir receives filtered fluid from the filter assembly; a first flow valve located within the second reservoir, the first flow valve having a bottom surface forming a recess for entrapping air when the second reservoir fills with fluid, and a first seal aligned with the second aperture such that when the second reservoir reaches a maximum fill level, the first flow valve rises with a pre-determined buoyancy force, such that the first seal of the first flow valve stops fluid flow from the first reservoir to the second reservoir; a third reservoir located adjacent the second reservoir, the third reservoir in fluid communication with the second reservoir, such that the third reservoir receives filtered fluid from the second reservoir, and provides at least one dispenser for fluid egress; and a second flow valve located within the third reservoir, the second flow valve having a bottom surface forming a recess for entrapping air when the third reservoir fills with fluid, and a second seal aligned with the third aperture such that when the third reservoir reaches a maximum fill level, the second flow valve rises with a pre-determined buoyancy force, such that the second seal of the second flow valve stops fluid flow from the second reservoir to the third reservoir.

The fluid dispenser may further include a pitcher filling mechanism comprising: a first plunger valve located on the pitcher for allowing fluid ingress upon activation; and a second complementary plunger valve located on a housing of the third reservoir, the second plunger valve in fluid communication the first plunger valve when the pitcher assembly is fully seated within the third reservoir housing such that the first and second plunger valves are activated and fluid is allowed to flow from the third reservoir to the pitcher assembly.

The pitcher assembly a pitcher base includes a first plunger valve recess for holding the first plunger valve and providing space for the first plunger valve refraction within the first plunger valve recess and extension beyond the pitcher base outer surface, and the housing of the third reservoir includes a second plunger valve recess for holding the second plunger valve and providing space for the second plunger valve retraction within the second plunger valve recess and extension beyond the housing of the third reservoir outer surface, wherein upon attachment of the pitcher assembly to the third reservoir housing the first plunger valve and the second plunger valve are not co-linear with one another.

The first reservoir bottom contoured surface is designed to include a recess for receiving a bottom portion of the filter assembly housing, wherein the first flow valve includes a reciprocally contoured top portion to mate with the first reservoir bottom contoured surface.

The filter housing may also include an extended handle for removably attaching the filter housing to the first reservoir bottom surface.

The pitcher assembly may include a pitcher base having a removable cover having a top sealably removable cap.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIGS. 1A and 1B depict the major components of a preferred embodiment of the countertop dispenser of the present invention;

FIG. 2 is an exploded view of the countertop dispenser of FIGS. 1A and 1B;

FIG. 3 depicts a side view of the pre-filter cover having a sidewall with slotted apertures for air venting to facilitate the drainage of water in the pre-filter into the top reservoir;

FIG. 4 depicts an exploded view of a removably attachable pitcher assembly for the countertop dispenser of the present invention;

FIG. 5 depicts a lower locking recess adjacent the finger grip on the pitcher assembly of FIG. 4, and a notch on the pitcher cover to facilitate removal from the pitcher base;

FIG. 6 depicts an exploded view of a filter assembly for the countertop dispenser of the present invention;

FIG. 7 depicts a partial exploded view of the filter assembly showing a snap fit mating of the filter housing with filter bottom cap;

FIG. 8 depicts an alternative slot configuration for the filter housing that includes a plurality of diversely shaped apertures for fluid ingress;

FIG. 9 is a cut-away, partial cross-sectional view of the countertop water dispenser of the present invention depicting the placement of the filter assembly and detailing the shape of the contoured bottom surface of the top reservoir, shaped for receiving the filter assembly;

FIG. 10 depicts a detailed cut-away cross-sectional view of FIG. 8 of the filter housing inserted within the contoured bottom surface of the top reservoir and the complementary shape of the first flow valve;

FIG. 11 depicts a top perspective view of the third or bottom reservoir 28 and stand 29;

FIG. 12 is a top view of a partially inserted pitcher assembly, the pitcher assembly being inserted within the compartment formed within the third or bottom reservoir and stand;

FIG. 13A depicts the pin or plunger valves of the pitcher filling mechanism in their “OFF” state when the plunger valves are not activated by complete insertion of the pitcher assembly;

FIG. 13B depicts the pitcher filling mechanism of FIG. 13A upon “plug in”, at a point in the interlocking process when each plunger valve comes in contact with an opposing structure, when the plunger valves are not yet activated;

FIG. 13C depicts the pitcher filling mechanism of FIG. 13A when the plunger valves are fully activated;

FIG. 14A depicts the mating of the middle reservoir with the lower reservoir;

FIG. 14B is an exploded view of the mating of the middle reservoir with the lower reservoir shown in FIG. 14A; and

FIG. 15 depicts a transparent view of the countertop water dispenser of the present invention depicting the placement of the filter assembly, first and second flow valves, and pitcher assembly with water in the bottom reservoir.

### DESCRIPTION OF THE PREFERRED EMBODIMENT(S)

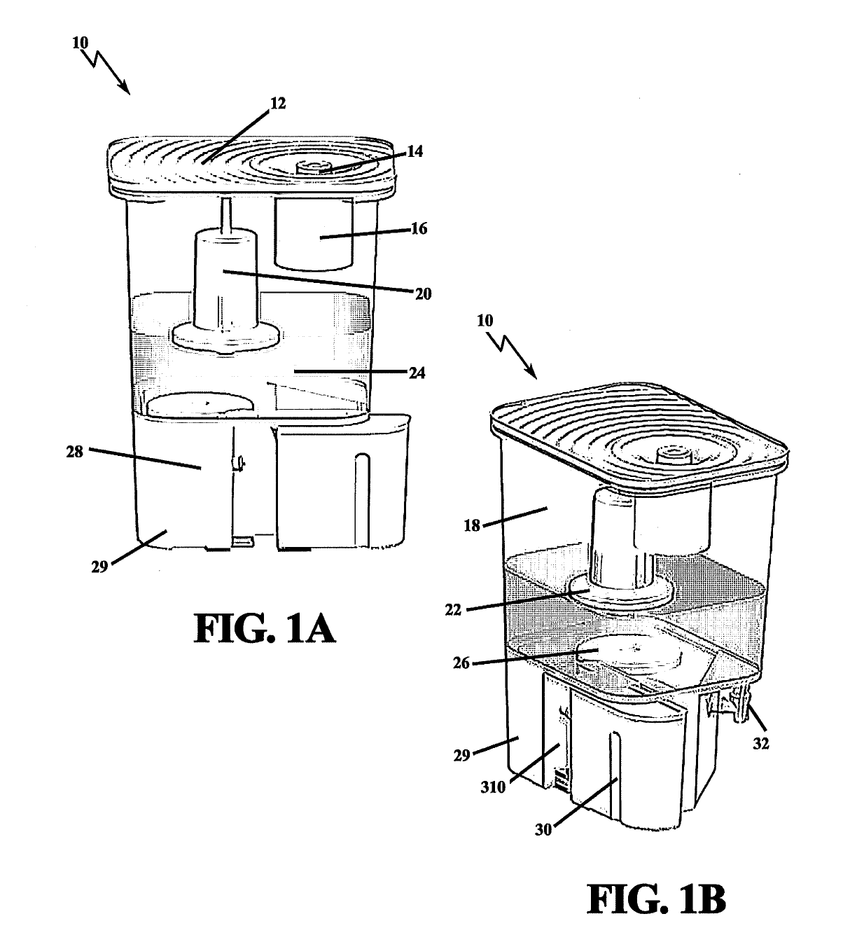

In describing the preferred embodiment of the present invention, reference will be made herein to FIGS. 1-15 of the drawings in which like numerals refer to like features of the invention.

The present invention is directed to a non-plumbed, non-electronic water filter and dispenser, specifically designed for operation on a countertop or other general location in a household. The water dispenser includes two forms of dispensing: one for direct extraction through an egress spigot for filling a vessel such as a cup; and the other via a removably attachable storage unit or pitcher that allows the user to remove from the countertop dispensing unit a larger quantity of filtered water for use in a different location.

Referring to FIGS. 1A and 1B, a preferred embodiment of the countertop dispenser of the present invention is generally designated by reference numeral 10. Countertop dispenser 10 includes a multiple reservoir design, preferably a three-tiered reservoir design with associated flow control and/or shut-off valves as discussed in further detail herein.

Components of countertop dispenser 10 include: a top reservoir cover 12 having an aperture 34 that is capped by a pre-filter cover 14; a pre-filter assembly 16 presenting a first level of filtration for ingress water; a first or top reservoir 18 receiving water from pre-filter assembly 16; a filter assembly 20 receiving water in top reservoir 18 and providing a second level of water filtration; a first flow control/shut-off valve (first flow valve) 22 regulating and ceasing flow from top reservoir 18; a second or middle reservoir 24 receiving filtered water from filter assembly 20; a second flow control/shut-off valve (second flow valve) 26 regulating and ceasing flow from middle reservoir 24; a third or bottom reservoir 28 receiving water from middle reservoir 24 and providing at least two paths of egress for the filtered water; a base 29 for bottom reservoir 28; a pitcher assembly 30 establishing one egress path for filtered water and removably attachable to compartment 310 in third reservoir 28 and base 29; and a dispensing spigot 32 providing a second egress path for filtered water. Each component will be discussed in further detail herein with reference to applicable figures.

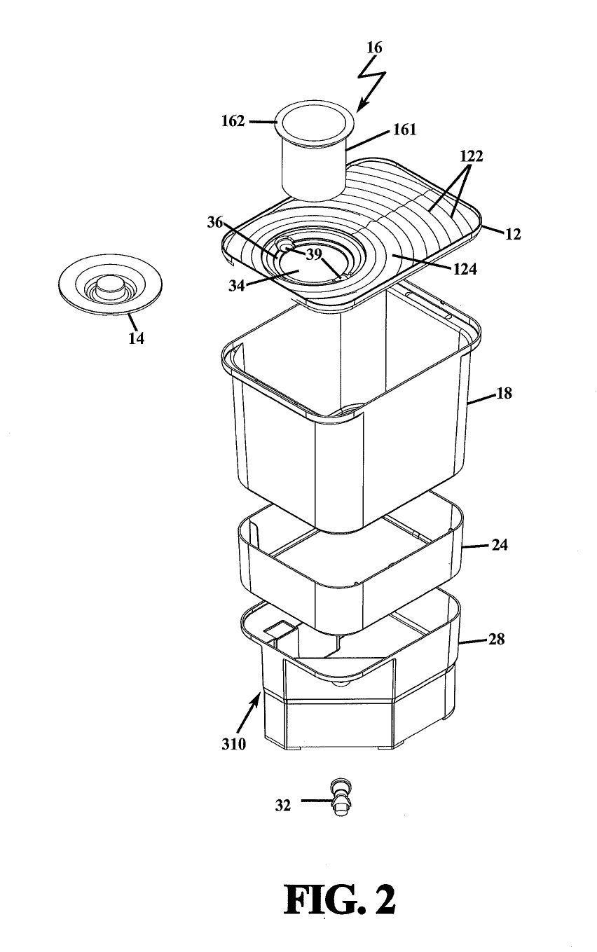

FIG. 2 is an exploded view of countertop dispenser 10. Top reservoir cover 12 includes an off-center, circular aperture 34 for receiving and supporting the slideably insertable pre-filter assembly 16. Pre-filter assembly 16 is predominantly a sediment filter for removing larger particles from the unfiltered water upon initial filling of first reservoir 18. Pre-filter assembly 16 includes a preferably cylindrically shaped housing 161 having a radius slightly smaller than the radius of off-center aperture 34 to allow for easy insertion in aperture 34 of top reservoir cover 12. Pre-filter assembly 16 includes multiple apertures in cylindrically shaped housing 161 for allowing fluid to flow into top reservoir 18. The top of cylindrical housing 161 includes an extended circumferential lip 162 that rests on circular shelf 36 of top reservoir cover 12, which defines aperture 34. In this manner, cylindrical housing 161 can be slideably inserted within aperture 34 and held in place and supported by circumferential lip 162 fitting on shelf 36. Other attachment and containment schemes for pre-filter assembly 16 including snap-on fit, friction fit, and threaded fit schemes are possible, and the present invention is not limited to any particular pre-filter assembly attachment design.

Although aperture 34 is preferably circular to receive cylindrical housing 161, it is understood that other shaped configurations are easily adaptable for the countertop pre-filter design of the present invention, such as oval, square, triangular, obround, or the like. Certain shapes may be more inclined to accommodate particular pre-filter media and thus the cross-sectional shape of the pre-filter assembly may be something other than circular for receiving a cylindrical housing; rather, for instance, it may be square or rectangular to receive a flat sheet media filter.

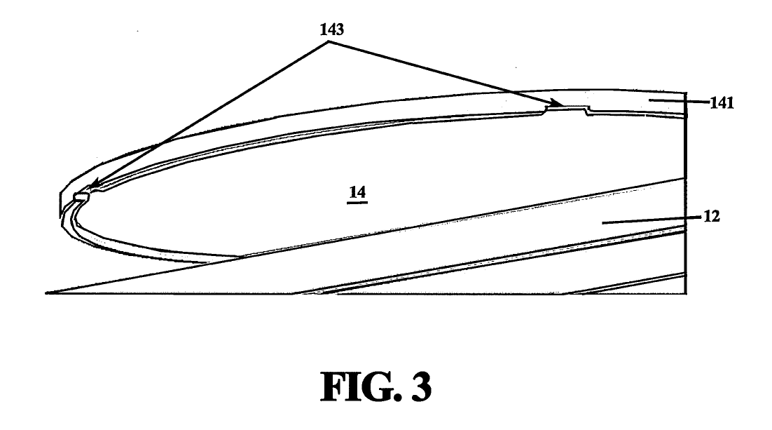

The easily removable pre-filter cover 14 is designed to be placed over and cap aperture 34, to allow a user easy access to filter media held in pre-filter assembly 16. Pre-filter cover 14 also keeps unwanted objects, dirt, dust, and other particles from falling within the filter media in pre-filter assembly 16. In a preferred embodiment, pre-filter cover 14 is simply placed on aperture 34, the pre-filter cover 14 having a larger diameter than aperture 34, resting on circular shelf 36 of top reservoir cover 12. FIG. 3 depicts a side view of pre-filter cover 14 having a sidewall 141 with slotted apertures 143 for air venting to facilitate the drainage of fluid in pre-filter 16 into top reservoir 18.

In normal operation, for a countertop fluid dispenser of the present invention that includes a pre-filter assembly, a user removes pre-filter cover 14 and pours unfiltered water into pre-filter assembly 16. The filter media for pre-filter assembly 16 is preferably designed as a first stage filter media, such as a sediment filter, which generally includes a cloth, mesh, fabric, or paper, and the like. This media may be treated for removing particulate contaminants from the water, and if treated, may further remove microbiological and heavy metal contaminants. Treating filter media to remove microbiological and heavy metal contaminants is a continuing challenge in the art, and known processes for treating filter media to remove such contaminants may be employed to the pre-filter filtration media to establish a more robust and effective water purifier.

In fact, the Environmental Protection Agency (EPA) has set forth minimum standards for acceptance of a device proposed for use as a microbiological water purifier. Common coliforms, represented by the bacteria E. coli and Klebsiella terrigena, must show a minimum 6-log reduction, 99.9999% of organisms removed. Common viruses, represented by poliovirus 1 (LSc) and rotavirus (Wa or SA-11), which show resistance to many treatment processes, must show a minimum 4 log reduction, 99.99% of organisms removed, from an influent concentration of 1×10⁷/L. Cysts, such as those represented by Giardia muris or Giardia lamblia, are widespread, disease-inducing, and resistant to chemical disinfection. Devices that claim cyst removal are required show a minimum 3 log reduction, 99.9% of cysts removed, from an influent concentration of 1×10⁶/L or 1×10⁷/L, respectively. The EPA has accepted the use of other particles in the appropriate size range as a means of testing devices that claim this function.)

Treatment of the pre-filter assembly filter media for microbiological contaminants may include filters that comprise membranes, such as hollow filter membranes or spiral wound flat sheet membranes with pores of a size appropriate for removing microbiological contaminants which may be designed to the specifications dictated by the EPA.

Top reservoir shelf 36 is a circular shelf having at least one recess, and preferably two diametrically opposed recesses 39 to assist a user in grasping by hand extended circumferential lip 162 of pre-filter cover 14 to accommodate the slide-and-hold design of the preferred embodiment.

Top reservoir cover 12 is designed with arcuate ridges 122 resembling waves of water, each arcuate ridge approximately concentric with one another, having a radius that emanates from the center of aperture 34. Since aperture 34 is off-center, that is, placed more towards one side of top reservoir cover 12 than the other side, the arcuate ridges 122 emanating from aperture 34 have longer arc lengths further away from the center of aperture 34 with the largest arc length adjacent the side of top reservoir 12 opposite aperture 34. One arcuate ridge 124 is heightened (taller or higher) than other arcuate ridges 122. Ridge 124 is designed to provide air space for the air vent of filter assembly 20.

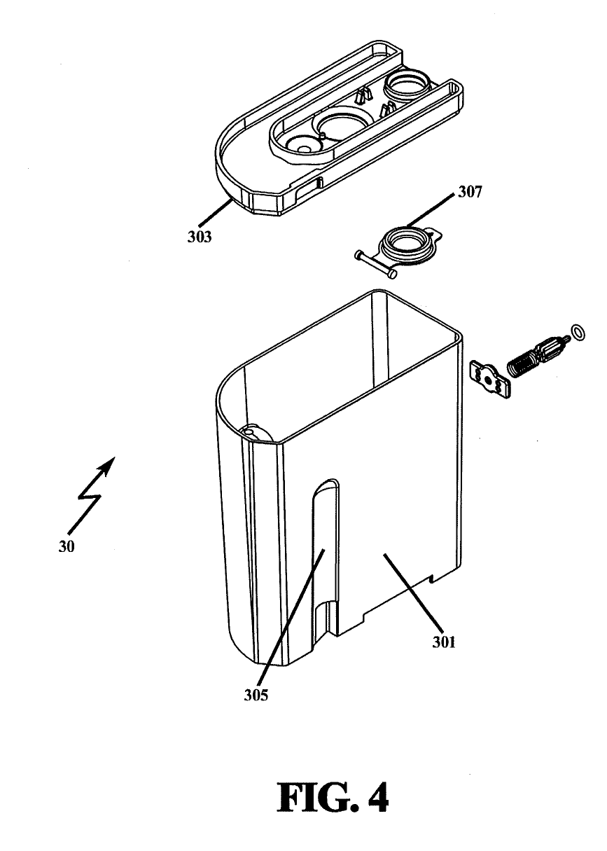

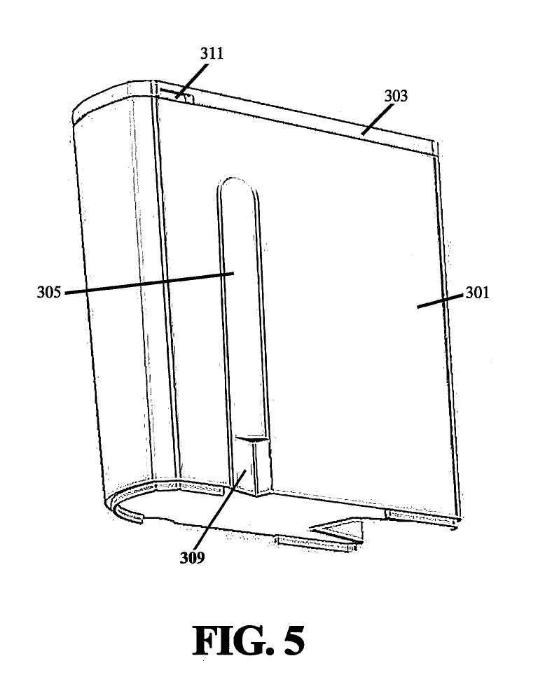

FIG. 4 depicts an exploded view of pitcher assembly 30. Pitcher assembly 30 is designed to fit within, and be removably attachable from, compartment 310 formed in adjacent sections of third reservoir 28 and base 29. Pitcher assembly 30 includes a pitcher base 301 and a pitcher cover 303. Pitcher base 301 may also include a grooved recess or indent for a finger grip 305 to facilitate in removing and holding pitcher assembly 30. Pitcher cover 303 may include a securing cap 307 to prevent water spillage when transporting pitcher assembly 30. As depicted in FIG. 5, a lower locking recess 309 is provided adjacent finger grip 305 that is designed to mate with a lower back lug on base 29. Pitcher cover 303 may further include a recess or notch 311 to facilitate gripping of pitcher cover 303 and subsequent removal from pitcher base 301.

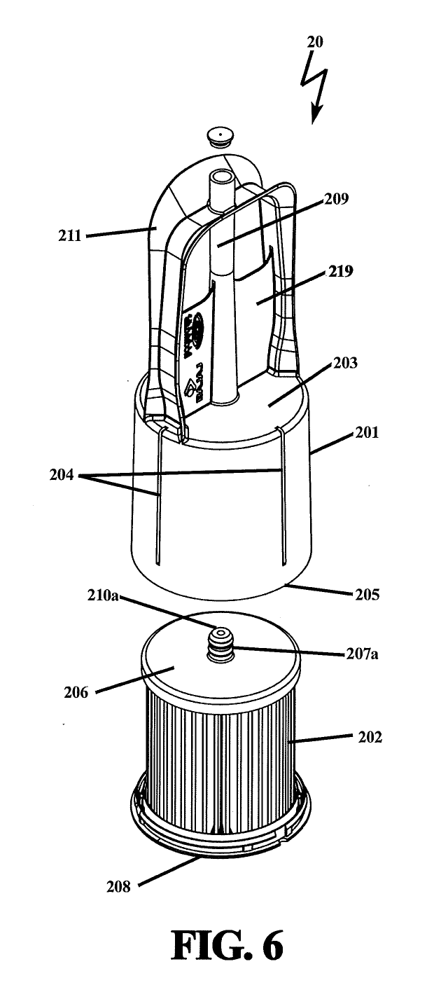

FIG. 6 depicts an exploded view of filter assembly 20. Filter assembly 20 comprises a housing 201 that encloses filter media 202. In a preferred embodiment, housing 201 is cylindrical, having a filter housing top surface 203 and sidewalls that include a plurality of slots or apertures 204 for water ingress, the slots preferably being placed circumferentially around the sidewalls. Slots 204 are shown as elongated, longitudinal apertures traversing in the axial direction from approximately filter housing top surface 203 of housing 201 to the housing bottom portion or base 205. At least one slot 204 is preferably extended to the top of housing 201 for air-bleed during water ingress, while the lower end of slots 204 are preferably extended close to the base 205 of housing 201.

Other filter housing shapes may be accommodated, and the present invention is not limited to a cylindrical configuration. For example, flat sheet filter media in a box-shaped housing may be utilized in lieu of cylindrically shaped media. Independent of the filter housing shape, any associated sidewalls or bottom base should include at least one aperture for water ingress and at least one aperture for water egress.

The filter media 202 of filter assembly 20 may be a carbon composite media, a fibrous sheet media, granular media, or any combination thereof, and the present invention is not limited to any particular type of filter media provided the filter assembly housing is appropriately modified to contain fully the filter media while allowing for adequate water flow. Filter media 202 may also be treated, and preferably is treated for various contaminants, independent of whether the pre-filter filtration media is treated. In an exemplary embodiment, filter media 202 may have a pH altering material that allows more efficient capture of microbiological contaminants by the composite filter medium. If filter media 202 is treated, a positively charged medium is preferably utilized, such as a solid composite block. The pH altering material may be a flat sheet structure wrapped around the positively charged medium. The positively charged medium can also be admixed with the pH altering material and a binder, and extruded to form a solid composite block. The pH altering material may further comprise a flat sheet structure positioned upstream from the positively charged medium. The pH altering material may be designed to be periodically regenerated.

The charged medium may be admixed with a binder and fused onto a substrate forming a charged layer, wherein the charged layer and the pH altering layer are spiral wound such that the pH altering layer is exposed to the influent prior to the influent contacting the charged layer. The pH altering layer can also be fused to a second surface of the substrate.

Other treatments may be used on filter media 202 to target specific contaminants for a given environmental condition, and the present invention is not limited to any particular treatment known in the art.

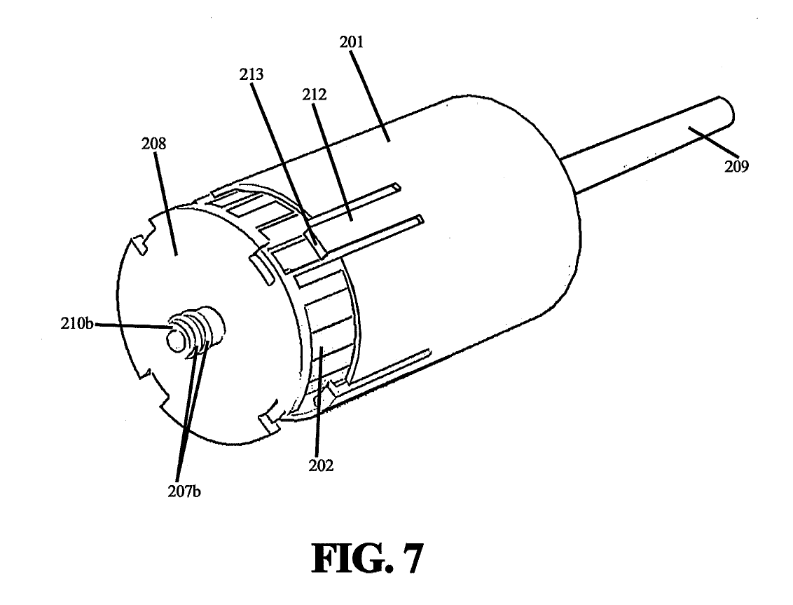

Referring to FIG. 6, base 205 of filter assembly 20 is in one embodiment open for receiving cylindrical filter media 202; in this manner there is little or no structure on the bottom end that would otherwise form a cap or bottom surface. Filter media 202 is designed to be slideably inserted within housing 201 from its base end. In a preferred embodiment, filter media 202 is sealed at the top by filter top cover 206, which is usually permanently affixed to the top end of the filter media, and sealed at the bottom by filter bottom cover 208, affixed to filter media 202 in a similar manner as top cover 206. Generally, top and bottom covers 206, 208 are secured to the filter media by adhesive or other bonding to form a permanent structure. When filter media 202 is slideably inserted within base 205, the media is sealed in place at the top by a set of resilient seals 207a that form a water-tight seal. Resilient seals 207a are located on a small, preferably cylindrical post 210a on top cover 206 that is coaxial with the center of cylindrical filter media 202. Resilient seals 207a are typically double O-rings that provide a water tight seal upon insertion within an air vent tube 209 that extends above filter housing top surface 203; however, a single O-ring seal may be sufficient for a water-tight interface. Filter bottom cover 208 may also be secured to base 205 by friction fit, snap-fit, threaded fit, or the like. One such attachment scheme is depicted in FIG. 7 discussed below.

Resilient seals 207b are located at the base of filter housing 202 on a portion of filter bottom cover 208. Specifically, and preferably, resilient seals 207b are located on a small, cylindrical post 210b on bottom cover 208 that is coaxial with the center of cylindrical filter media 202. Resilient seals 207b are typically double O-rings that provide a water tight seal upon insertion within flow control valve 22; however, a single O-ring seal may be sufficient for a water-tight interface.

In this exemplary embodiment, base 205 of filter housing 201 is secured to filter bottom cover 208 generally by snap, screw, or friction fit, or other securable operation that need not form a water-tight interface. A water-tight interface is not necessary at this secured point because resilient seals 207b, inserted within a cylindrical recess 183 in the bottom surface or floor 181 of the top reservoir 18 form the necessary water-tight junction that prohibits unfiltered water from entering middle reservoir 24.

FIG. 7 depicts a partial exploded view of filter assembly 20 showing a snap fit mating of filter housing 201 with filter bottom cap 208. This exemplary snap fit mating is demonstrated by a z-assembly snap-on configuration, which includes a plurality of resilient housing tabs 212, each with an angled extension 213 at their end for slideably extending housing tabs 212 radially outwards when pushed against bottom cover 208 until the extensions 213 are pushed beyond bottom cover 208, at which point the extensions 213 retract in the radial direction and clip or securely snap against the bottom surface of bottom cover 208. Bottom cover 208 may include a recess for a more secure snap fit when interacting with extensions 213.

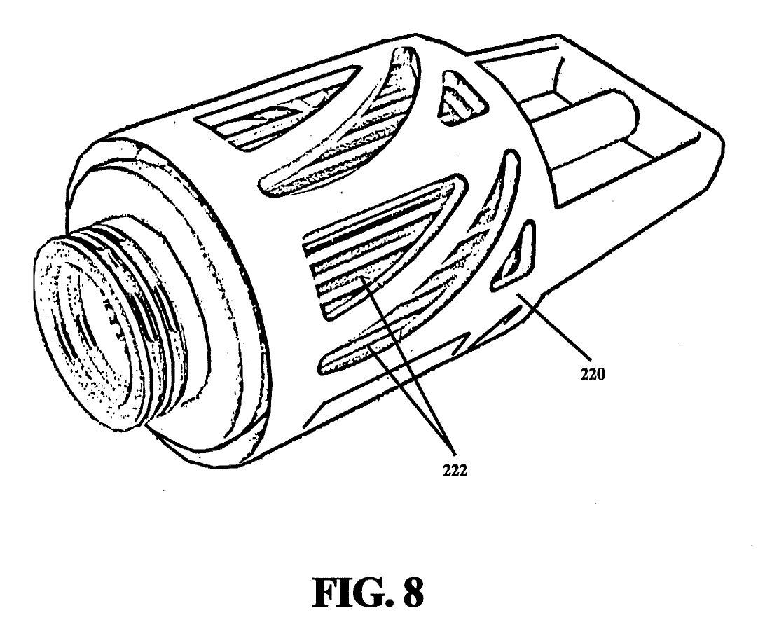

FIG. 8 depicts alternative slot configurations 222 for filter housing 220 that includes a plurality of the diversely shaped apertures for fluid ingress.

An air vent tube 209 extends axially upwards from filter housing top surface 203 and is preferably integral with filter housing top surface 203. Air vent tube 209 is centered about housing 201, is coaxial with cylindrical post 210a, and thus is coaxial with the center of cylindrical filter media 202. Air vent tube 209 allows air to flow upwards as water enters through slots 204 and replaces the air in the filter media. The air egress allows for a steady flow of fluid through the filter media that would otherwise be slowed by the formation of air bubbles.

The topmost portion of air vent 209 is designed to extend above the maximum fill line for unfiltered water in top reservoir 18. This extension is accomplished by having air vent 209 extend within heightened arcuate ridge 124 of top reservoir cover 12 to release air forced upwards by the unfiltered water entering filter media 202. If air vent tube 209 does not extend beyond the maximum fill line of unfiltered water, it would be possible for unfiltered water to enter middle reservoir 24 via air vent tube 209 and the center aperture of filter media 202 without traversing through filter media 202. Extending air vent tube 209 above the maximum fill line is one way of prohibiting unfiltered water from reaching the lower reservoirs without filtration. Other methods such as implementing one way valve in the air vent tube could also be employed to achieve a similar result.

Housing 201 may further include a handle 211 to assist a user in removing filter assembly 20 from top reservoir 18, and replacing a new filter therein. In the preferred design, strengthening ribs 219 are formed between air vent 209 and handle 211 to provide extra support for rotational forces if the handle is twisted during removal or insertion of housing 201. Handle 211 may be integral with housing 201 and/or filter housing top surface 203. Strengthening ribs 219 may be wide, flat surfaced structures to accommodate identification nomenclature and other insignia.

Housing 201 is designed to be a reusable housing. As discussed above, the housing 201 does not have a significant bottom portion, insomuch as the filter bottom cover 208 is designed to form the bottom portion of filter assembly 20; however, in an alternative embodiment, housing 201 may include a removable bottom portion for enclosing filter media 202. In the preferred embodiment, housing 201 is removed from top reservoir bottom surface 181, filter media 202 is removed and replaced with new filter media, and housing 201 is reinserted into the contoured bottom surface 181 of top reservoir 18.

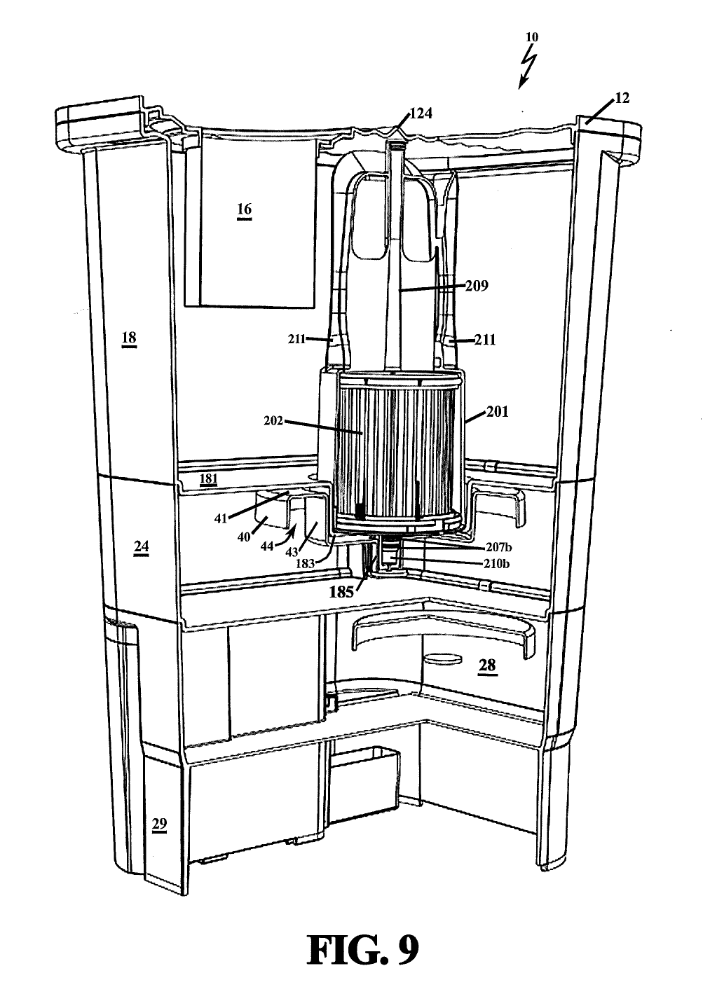

FIG. 9 is a cut-away, partial cross-sectional view of the water dispenser 10, depicting the placement of filter assembly 20. As shown, filter assembly 20 is located adjacent to pre-filter assembly 16 in order to provide space for both filters in the same reservoir. In this figure, filter assembly 20 is shown sealably secured within filter housing 201 by resilient seals 207a forming a water-tight seal within the base of air vent tube 209 at the top end of filter housing 201. The contoured bottom surface or floor 181 of top reservoir 18 includes a shaped cylindrical recess 183 for receiving filter housing 201. Filter assembly 20 is secured within cylindrical recess 183 in the lower part of top reservoir 18. This low placement of filter assembly 20 increases the head pressure and reduces the amount of stagnant, residual water that otherwise would remain in the top reservoir. Cylindrical recess 183 has a slightly larger radius than the outer radius of filter housing 201 to allow filter housing 201 to be inserted therein. Extending axially downwards from recess 183, and coaxial with recess 183, is a smaller formed cylindrical recess 185 in bottom surface 181 that is designed for receiving cylindrical post 210b of filter bottom cover 208. The O-ring seals 207b of cylindrical post 210b form a water-tight seal with the inner wall of cylindrical recess 185 of top reservoir floor 181. Thus, water must flow from top reservoir 18 through apertures or slots 204 in filter housing 201, through filter media 202, exiting from the center aperture of cylindrical post 210b in order to fill middle reservoir 24. Filter housing 201 is secured by a press or friction fit in the contoured bottom surface 181 but may be secured by a threaded interface or other releaseably securable process.

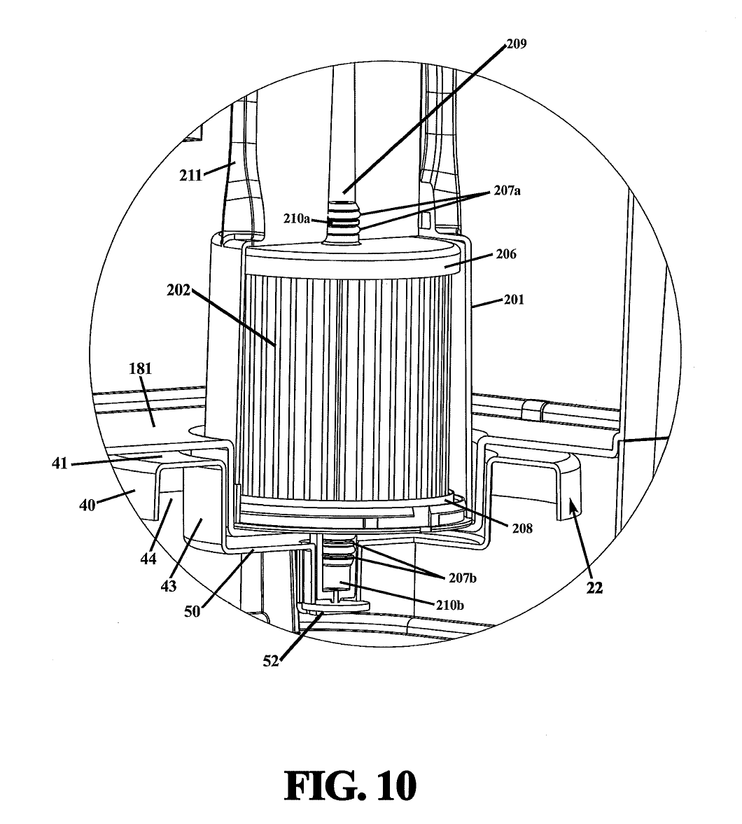

In at least one embodiment a float or flow valve may be used to regulate and stop flow from the first reservoir to the second reservoir, and if desirable, a second flow valve may be used to regulate or stop flow from the second reservoir to the third reservoir. A detailed cross-sectional view of flow valve 22 is depicted in FIGS. 9 and 10, identifying the preferred shape of flow valve 22. Flow valve 22 is located in middle reservoir 24, directly underneath and coaxial with filter assembly 20. Starting from the circular outer edge of flow valve 22, a peripheral outer sidewall 40 extends longitudinally downwards from top surface 41. A circular, peripheral sidewall 43, coaxial with outer sidewall 40, extends longitudinally downwards from top surface 41, forming a downward facing, open bottom, cylindrical recess 44 which is exposed on the underside of flow valve 22. Cylindrical recess 44 is exposed on the bottom surface of flow valve 22 for capturing air when middle reservoir 24 fills with filtered water. The appropriate size of cylindrical recess 44 is predetermined based on the buoyancy force acting on flow valve 22 when water fills middle reservoir 24. By capturing air, float valve 22 rises towards the bottom floor 181 of top reservoir 18. Flow valve 22 forms a cylindrical recess 50 extending axially downward from top surface 41. Cylindrical recess 50 is formed by sidewalls 43 and is coaxial with recess 183, and slideably receives recess 183 when flow valve 22 is raised by captured air in recess 44. By its upward movement, flow valve 22 brings a seal 52, preferably an open face seal, in sealable contact with the center water egress passageway of cylindrical post 210b, thus blocking water flow from top reservoir 18 to middle reservoir 24 when middle reservoir 24 reaches is maximum fill point.

Cylindrical recess 44 for capturing air and raising flow valve 22 is defined by an inside diameter Dᵢ (which is the outside diameter of inner sidewall 43) and an outside diameter Dₒ (which is the inside diameter of outer sidewall 40). The preferred design of flow valve 22, having top and bottom shaped cylindrical shells for filter assembly insertion and air gap formation, will rise with rising water level based on the following expression:

$$\{ {π ( \frac{{D}_{o}}{2} )}^{2} - {π ( \frac{{D}_{i}}{2} )}^{2} \} ⋆ h ⋆ {δ}_{ω} > Wp \qquad ( 1 )$$

where,

Dₒ=inside diameter (cm) of outer sidewall 40 that forms the outer wall of recess 44;

Dᵢ=outside diameter (cm) of inner sidewall 43 that forms the inner wall of recess 44;

h=height of recess 44;

δ_{ω}=density of water (g/cm³); and

Wₚ=weight of flow valve 22

Preferably, the flow valve 22 is fabricated of a light, durable plastic or other light-weight material for reacting to the buoyancy force exerted upon it by the rising water in the middle reservoir. The inequality of equation (1) represents the turning point when the buoyancy force exceeds the weight of the water displaced by the air trapped in the air gap, and float valve 22 commences to rise and control flow and ultimately shut off filtration by forming a seal between open face seal 52 and cylindrical post 210b. Thus, flow valve 22 is designed in accordance with equation (1) to ensure adequate lift when acted upon by a sufficient buoyancy force.

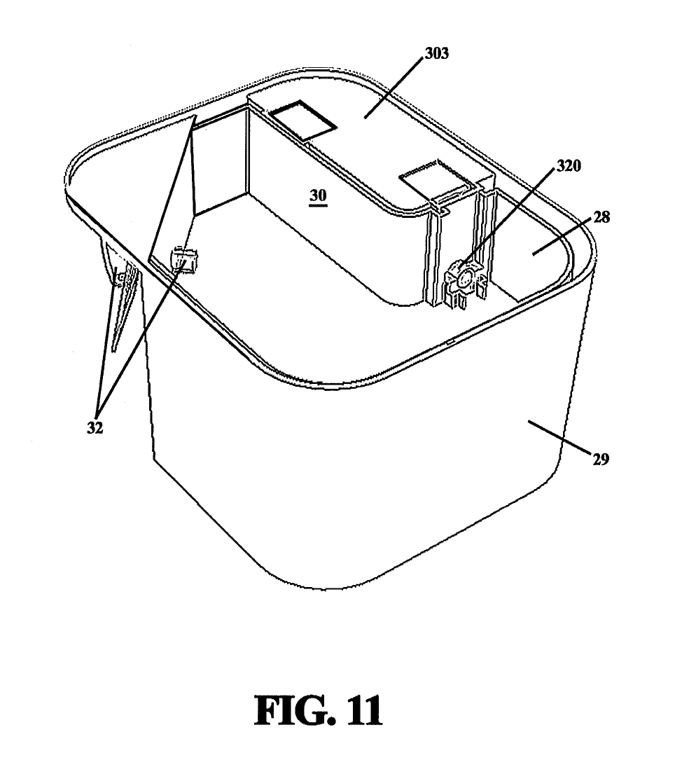

FIG. 11 depicts a top perspective view of the third or bottom reservoir 28 and stand 29. As shown, spigot or spout 32 and pitcher filling mechanism 320 share the same reservoir 28, which is designed to minimize the amount of stagnant water in the system. For example, a higher spigot would allow for taller vessels to be spigot-filled; however there would be more stagnant water in reservoir 28, which is undesirable and counter to making available continuously filtered water. Conversely, reducing stagnant water by simply raising the tank volume would reduce the usable volume of reservoir 28.

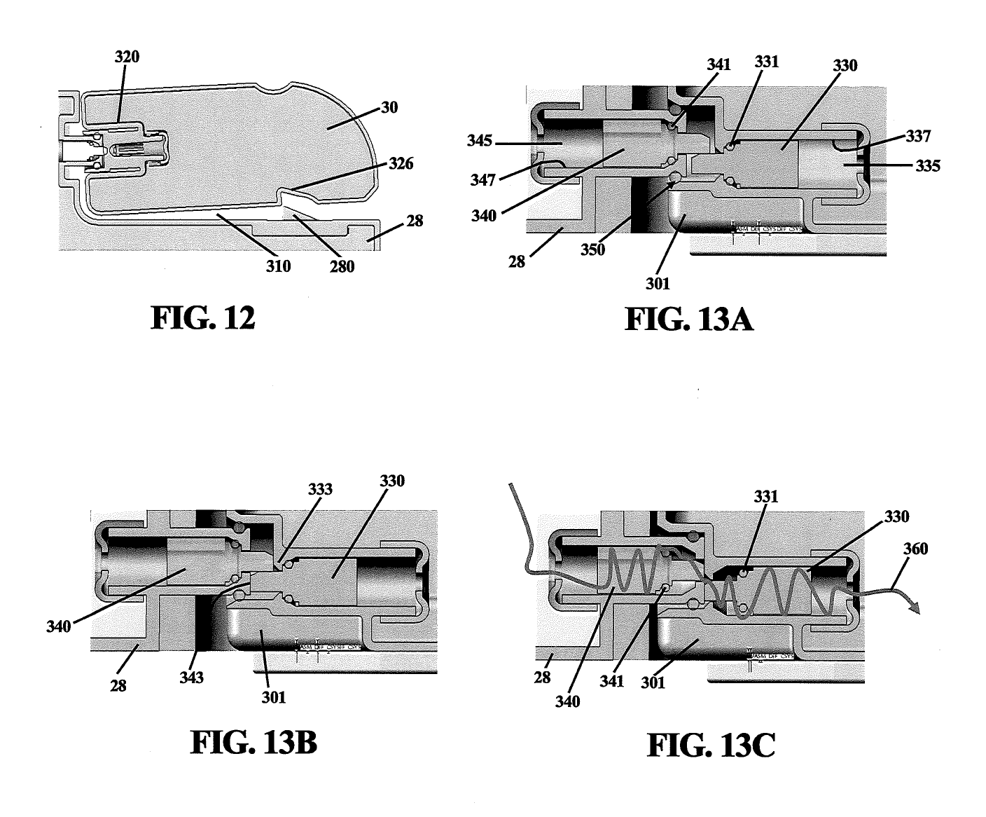

FIG. 12 is a top view of pitcher 30 being inserted within compartment 310 formed within reservoir 28 and stand 29. As shown, pitcher assembly 30 may be fastened in place by a pressure fit established by an angled protrusion 280 extending into recess 326 of pitcher assembly 30. Other attachment schemes may be used to secure pitcher assembly 30 to reservoir 28 and stand 29, and the present invention is not limited to any particular attachment scheme provided that pitcher assembly 30 is easily removable, and once press fitted against the third reservoir 28 and stand 29 structure, filling mechanism 320 remains leak free

FIGS. 13A-C depict pitcher filling mechanism 320 in more detail. Pitcher filling mechanism 320 comprises two interacting pin or plunger valves 330, 340 that in the exemplary embodiment are not co-linear with one another. Plunger valve 330 is located within pitcher base 301, and plunger valve 340 is located within third reservoir 28 and stand 29 structure. FIG. 13A depicts the plunger valves of the pitcher filling mechanism in their “OFF” state, when no water is capable of flowing. In this state, as shown in the figure, the plunger valves are out of alignment with one another, not sharing the same longitudinal axis. FIG. 13A depicts the moment when the head of each plunger valves has yet to contact the opposing structure, as the pitcher base 301 and lower reservoir 28 remain a distance apart, and each structure is distanced from the opposing plunger valve head. At this juncture, there has been no retraction of either plunger valve. An exterior O-ring seal 350 is used to prevent leakage to the outside of either structure upon attachment, and at this stage of attachment begins to provide a sealing interface to the pitcher filling mechanism.

Each plunger valve may reside in a recess in its respective structure. In at least one embodiment, plunger valve 330 resides in recess 335, and remains in slideable communication with the interior sidewalls 337 of recess 335. An O-ring seal 331 circumscribes the shoulder portion of plunger valve 330 such that in its OFF state, no water can flow out of pitcher base 301. Similarly, plunger valve 340 resides in recess 345, and remains in slideable communication with interior sidewalls 347 of recess 345. An O-ring seal 341 circumscribes the shoulder portion of plunger valve 340 such that in its OFF state, no water can flow out of lower or bottom reservoir 28 and stand 29.

FIG. 13B depicts the pitcher filling mechanism upon “plug in”, at a point in the interlocking process when each plunger valve comes in contact with the opposing structure; the head of plunger valve 340 being in contact with the inner surface wall 333 of pitcher base 301, and simultaneously, the head of plunger valve 330 is in contact with the inner surface wall 343 of the third reservoir/stand structure. At this juncture in the connection process the plunger valves are set to activate.

FIG. 13C depicts the pitcher filling mechanism when the plunger valves are fully activated in the “ON” position. Each structure inner surface wall 333, 343 presses against the head of the opposing plunger valve 340, 330 respectively. The flow of water is represented by circuitous arrow 360 as the activated plunger valves are refracted within their respective recesses. Each inner O-ring 331, 341 are unsealed, and water is able to flow through and fill the pitcher until the water level of the pitcher and the water level of the lower reservoir are equal.

Upon removal of pitcher assembly 30 from lower reservoir 28 and stand 29, each plunger valve is restored to its OFF position as depicted in FIG. 13A and water is no longer able to flow out of either valve.

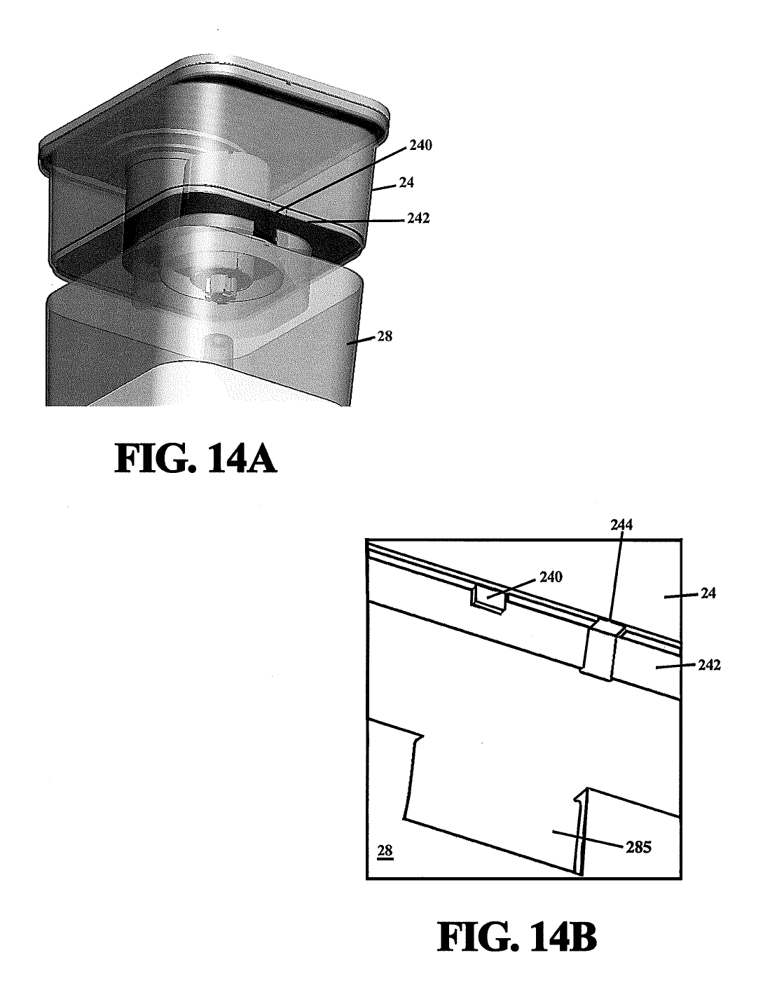

FIG. 14A depicts the mating of middle reservoir 24 with lower reservoir 28. An orientation rib 240 is located on the lower outer edge 242 of middle reservoir 24. As shown in the exploded view of FIG. 14B, orientation rib 240 is matched with slot 285 of the upper portion of lower reservoir 28. In addition, an air vent is provided to facilitate water drainage from middle reservoir 24 to lower reservoir 28. As shown in FIG. 14B, L-shaped slot 244 is formed within lower outer edge 242 to provide the air passageway. The air vent L-slot and orientation rib are exemplary embodiments for mating the two lower reservoirs, and the present invention is not limited to any particular directional rib configuration or air vent design provided such attributes are retained during mating of the reservoirs

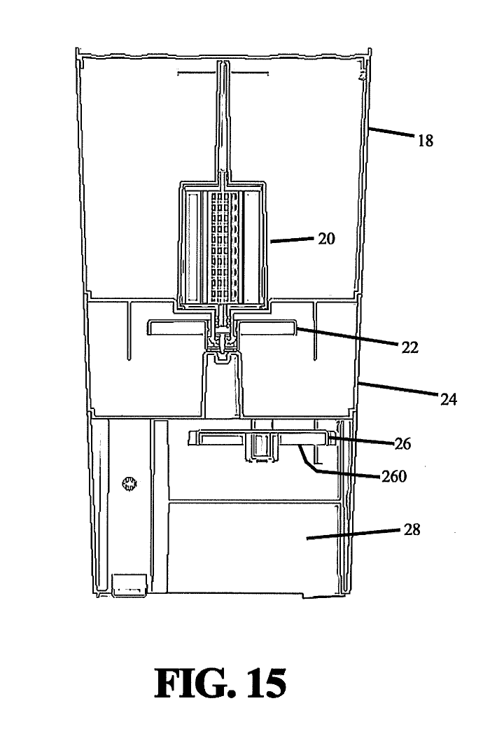

FIG. 15 depicts a transparent view of countertop water dispenser 10 depicting the placement of filter assembly 20, flow valve 22, pitcher assembly 30, and flow valve 26. Flow valve 26 is preferably similar in structure to flow valve 22 insomuch as it includes a recessed portion 260 on its underside for capturing air and creating an upward buoyancy force when water rises in lower reservoir 28. The presence of flow valve 26 minimizes the volume of stagnant water that could be retained in lower reservoir 28. Flow valve 26, if cylindrical like flow valve 22, is designed to meet the analytical criteria of equation (1) for having adequate buoyancy force.

The present invention as described relates to a countertop water dispenser having a three tiered reservoir system for filtering water and providing immediate dispensing via a spigot, and simultaneously filling a removable pitcher for transporting filtered water to another location. Water flow in the three tiered reservoir system may be controlled by flow valves that float with rising water to stop water flow when a maximum fill level is reached in a reservoir. A flow valve is provided in the middle reservoir as well as the lower reservoir to control the amount of filtered water in each reservoir. An air vent is provided on a filter housing, the air vent venting to a heightened arcuate rib on the countertop dispenser cover.

The removable pitcher is mated to the lower reservoir via a pitcher filling mechanism that includes respective plunger or pin valves to allow water to flow into the pitcher when the lower reservoir is filled with water above or equal to the height of the pitcher filling mechanism.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A fluid dispenser comprising:
a removable cover having a first aperture for fluid ingress;
a first reservoir for receiving ingress fluid, said first reservoir having a bottom surface with a second aperture therethrough;
a filter assembly located within said first reservoir and forming a fluid-tight seal with said second aperture within said first reservoir bottom surface;
a second reservoir having a bottom surface with a third aperture therethrough, said second reservoir located adjacent said first reservoir, and in fluid communication with said first reservoir, such said second reservoir receives filtered fluid from said filter assembly; and
a third reservoir located adjacent said second reservoir, said third reservoir in fluid communication with said second reservoir, such that said third reservoir receives filtered fluid from said second reservoir, and provides at least one dispenser for fluid egress.

2. The fluid dispenser of claim 1 including a pre-filter slideably attachable to said first aperture of said removable cover.

3. The fluid dispenser of claim 1 including a first flow valve located within said second reservoir, said first flow valve having a bottom surface forming a recess for entrapping air when said second reservoir fills with fluid, and a first seal aligned with said second aperture such that when said second reservoir reaches a maximum fill level, said first flow valve rises with a pre-determined buoyancy force, such that said first seal of said first flow valve stops fluid flow from said first reservoir to said second reservoir.

4. The fluid dispenser of claim 1 including a second flow valve located within said third reservoir, said second flow valve having a bottom surface forming a recess for entrapping air when said third reservoir fills with fluid, and a second seal aligned with said third aperture such that when said third reservoir reaches a maximum fill level, said second flow valve rises with a pre-determined buoyancy force, such that said second seal of said second flow valve stops fluid flow from said second reservoir to said third reservoir.

5. The fluid dispenser of claim 3 wherein said pre-determined buoyance force of said first flow valve is calculated for a cylindrical recess of said first flow valve from the expression:
$$\{ {π ( \frac{{D}_{o}}{2} )}^{2} - {π ( \frac{{D}_{i}}{2} )}^{2} \} ⋆ h ⋆ {δ}_{ω} > Wp$$
where, Dₒ is the inside diameter of the outer sidewall that forms the outer wall of the first flow valve recess; Dᵢ is outside diameter of inner sidewall that forms the inner wall of the first flow valve recess; h is the height of the recess; δ_{ω} is density of the fluid; and Wₚ is the weight of said first flow valve.

6. The fluid dispenser of claim 4 wherein said pre-determined buoyance force of said second flow valve is calculated for a cylindrical recess of said second flow valve from the expression:
$$\{ {π ( \frac{{D}_{o}}{2} )}^{2} - {π ( \frac{{D}_{i}}{2} )}^{2} \} ⋆ h ⋆ {δ}_{ω} > Wp$$
where, Dₒ is the inside diameter of the outer sidewall that forms the outer wall of the second flow valve recess; Dᵢ is outside diameter of inner sidewall that forms the inner wall of the second flow valve recess; h is the height of the recess; δ_{ω} is density of the fluid; and Wₚ is the weight of said second flow valve.

7. The fluid dispenser of claim 2 wherein said pre-filter comprises a cylindrical housing having a top circumferential lip and said first aperture in said removable cover includes a shelf structure for supporting said pre-filter cylindrical housing circumferential lip.

8. The fluid dispenser of claim 2 wherein said pre-filter includes a pre-filter filter media designed as a first stage filtration component for sediment, comprising a cloth, mesh, fabric, paper, or any combination thereof.

9. The fluid dispenser of claim 8 wherein said pre-filter filter media is treated for microbiological contaminants.

10. The fluid dispenser of claim 1 wherein said filter assembly includes:
a filter assembly filter media having a top cover and a bottom cover, said top cover including a post for air egress, said bottom cover including a post for fluid egress; and
a filter housing including a filter housing top and filter housing sidewalls encompassing said filter assembly filter media, said filter housing having apertures for fluid ingress.

11. The fluid dispenser of claim 10 wherein said filter housing top includes an elongated vent or tube in communication with said top cover post of said filter assembly filter media, said vent or tube having a top portion extending above said filter housing top above a maximum fill line of said first reservoir to release air and prevent fluid ingress.

12. The fluid dispenser of claim 11 wherein said removable cover includes at least one heightened arcuate ridge to receive and allow air egress from said vent or tube top portion.

13. The fluid dispenser of claim 1 wherein said at least one dispenser includes a pitcher removably attachable to, and in fluid communication with, said third reservoir, or a spigot in fluid communication with said third reservoir, or both.

14. A fluid dispenser comprising:
a removable top cover having a first aperture for fluid ingress;
a pre-filter supported by said removable cover;
a first reservoir for receiving ingress fluid, said first reservoir having a bottom surface with a second aperture therethrough, said first reservoir bottom surface contoured to receive a filter assembly, said second aperture formed within said contoured surface;
said filter assembly located within said first reservoir and forming a fluid-tight seal with said second aperture, said filter assembly including:
a filter assembly filter media having a top cover and a bottom cover, said top cover including a post for air egress, said bottom cover including a post for fluid egress; and
a filter housing including a filter housing top and filter housing sidewalls encompassing said filter assembly filter media, said filter housing having apertures for fluid ingress;
a second reservoir having a bottom surface with a third aperture therethrough, said second reservoir located adjacent said first reservoir, and in fluid communication with said first reservoir, such said second reservoir receives filtered fluid from said filter assembly;
a first flow valve located within said second reservoir, said first flow valve having a bottom surface forming a recess for entrapping air when said second reservoir fills with fluid, and a first seal aligned with said second aperture such that when said second reservoir reaches a maximum fill level, said first flow valve rises with a pre-determined buoyancy force, such that said first seal of said first flow valve stops fluid flow from said first reservoir to said second reservoir;
a third reservoir located adjacent said second reservoir, said third reservoir in fluid communication with said second reservoir, such that said third reservoir receives filtered fluid from said second reservoir, and provides at least one dispenser for fluid egress; and
a second flow valve located within said third reservoir, said second flow valve having a bottom surface forming a recess for entrapping air when said third reservoir fills with fluid, and a second seal aligned with said third aperture such that when said third reservoir reaches a maximum fill level, said second flow valve rises with a pre-determined buoyancy force, such that said second seal of said second flow valve stops fluid flow from said second reservoir to said third reservoir.

15. The fluid dispenser of claim 14 wherein said filter housing top includes an elongated vent or tube in communication with said top cover post of said filter assembly filter media, said vent or tube having a top portion extending above said filter housing top above a maximum fill line of said first reservoir to release air and prevent fluid ingress.

16. The fluid dispenser of claim 14 wherein said pre-determined buoyance forces of said first and second flow valves are calculated for each cylindrical recess of said first and second flow valves from the expression:
$$\{ {π ( \frac{{D}_{o}}{2} )}^{2} - {π ( \frac{{D}_{i}}{2} )}^{2} \} ⋆ h ⋆ {δ}_{ω} > Wp$$
where, Dₒ is the inside diameter of the outer sidewall that forms the outer wall of a respective flow valve recess; Dᵢ is outside diameter of inner sidewall that forms the inner wall of the respective flow valve recess; h is the height of the respective flow valve recess; δ_{ω} is density of the fluid; and Wₚ is the weight of the respective flow valve.

17. The fluid dispenser of claim 15 wherein said removable cover includes at least one heightened arcuate ridge to receive and allow air egress from said vent or tube top portion.

18. The fluid dispenser of claim 14 wherein said at least one dispenser includes a pitcher assembly removably attachable to, and in fluid communication with, said third reservoir, or a spigot in fluid communication with said third reservoir, or both.

19. The fluid dispenser of claim 18 including a pitcher filling mechanism comprising:
a first plunger valve located on said pitcher for allowing fluid ingress upon activation; and
a second complementary plunger valve located on a housing of said third reservoir, said second plunger valve in fluid communication said first plunger valve when said pitcher assembly is fully seated within said third reservoir housing such that said first and second plunger valves are activated and fluid is allowed to flow from said third reservoir to said pitcher assembly.

20. The fluid dispenser of claim 19 wherein said pitcher assembly a pitcher base having a first plunger valve recess for holding said first plunger valve and providing space for said first plunger valve retraction within said first plunger valve recess and extension beyond said pitcher base outer surface, and said housing of said third reservoir includes a second plunger valve recess for holding said second plunger valve and providing space for said second plunger valve retraction within said second plunger valve recess and extension beyond said housing of said third reservoir outer surface.

21. The fluid dispenser of claim 19 wherein upon attachment of said pitcher assembly to said third reservoir housing said first plunger valve and said second plunger valve are not co-linear with one another.

22. The fluid dispenser of claim 14 wherein said first reservoir bottom contoured surface includes a recess for receiving a bottom portion of said filter assembly housing.

23. The fluid dispenser of claim 22 wherein said first flow valve includes a reciprocally contoured top portion to mate with said first reservoir bottom contoured surface.

24. The fluid dispenser of claim 14 wherein said filter housing includes an extended handle for removably attaching said filter housing to said first reservoir bottom surface.

25. The fluid dispenser of claim 24 wherein said handle and said air vent are integral with said filter housing top.

26. The fluid dispenser of claim 14 wherein said third reservoir and said second reservoir form air vents at their adjacent attachment interface.

27. The fluid dispenser of claim 18 wherein said pitcher assembly includes a pitcher base having a removable cover having a top sealably removable cap.
